(19) United States
(12) Patent Application Publication
(10) Pub. No.: US 2016/0202884 A1
(43) Pub. Date: Jul. 14, 2016

(54) INFORMATION PROCESSING APPARATUS, STORAGE MEDIUM AND CONTROL METHOD

(71) Applicant: SONY CORPORATION, Minato-ku, Tokyo (JP)

(72) Inventors: Yoshihito OHKI, Tokyo (JP); Yasushi OKUMURA, Tokyo (JP); Tetsuo IKEDA, Tokyo (JP); Daisuke NAGANO, Kanagawa (JP); Daisuke SATO, Tokyo (JP)

(73) Assignee: SONY CORPORATION, Tokyo (JP)

(21) Appl. No.: 14/911,988

(22) PCT Filed: Jul. 11, 2014
(86) PCT No.: PCT/JP2014/003701

§ 371 Date: Feb. 12, 2016

(30) Foreign Application Priority Data
Aug. 22, 2013 (JP) 2013-172377

(51) Int. Cl. G06F 3/0484; G06F 3/0482; G06F 3/0485; G06F 3/0488

(52) U.S. Cl. CPC G06F 3/04845; G06F 3/04883; G06F 3/0482; G06F 3/04842; G06F 3/04886; G06F 3/0485

(57) ABSTRACT

Provided is an information processing apparatus including an activation unit to activate multiple applications in response to an external input, an image generation unit to generate multiple screens corresponding to the multiple applications, and a display control unit to perform such a control that the multiple screens generated by the image generation unit are displayed in parallel on a display screen. The display control unit performs such a control that a parallel display of first and second screens corresponding to first and second applications is switched to a parallel display of third and fourth screens corresponding to third and fourth applications, in response to a single external input.

### CROSS REFERENCE TO RELATED APPLICATIONS

This application claims the benefit of Japanese Priority Patent Application JP 2013-172377 filed Aug. 22, 2013, the entire contents of which are incorporated herein by reference.

### TECHNICAL FIELD

The present disclosure relates to an information processing apparatus, a storage medium and a control method.

### BACKGROUND ART

In late years, mobile terminals such as cellular phone terminals, smart phones and tablet terminals have spread rapidly. Generally, mobile terminals, which have a low processing performance and a small screen size compared to PCs (personal computers) and the like, have not been used with multiple applications activated simultaneously and displayed at once.

However, the simultaneous usage of multiple applications is gradually being performed, in connection with a processing performance improvement, an increase in screen size and an increase in resolution in recent mobile terminals. For example, the following PTL 1 proposes a multi-window management apparatus that display's multiple windows while varying the sizes, and thereby allows a target window to be easily found.

### CITATION LIST

### Patent Literature

[PTL 1]

WO 2008/090902

### SUMMARY

### Technical Problem

However, the above PTL 1 assumes about several applications that are previously determined, and is not suitable for the simultaneous usage of several tens to several hundreds of applications, which is general in recent mobile terminals such as smart phones.

Hence, the present disclosure proposes an information processing apparatus, a storage medium and a control method that make it possible to switch a group of multiple screens corresponding to multiple applications, to a group of multiple screens corresponding to multiple applications that are different.

### Solution to Problem

According to an embodiment of the present disclosure, there is proposed an information processing apparatus including an activation unit to activate multiple applications in response to an external input, an image generation unit to generate multiple screens corresponding to the multiple applications, and a display control unit to perform such a control that the multiple screens generated by the image generation unit arc displayed in parallel on a display screen. The display control unit performs such a control that a parallel display of first and second screens corresponding to first and second applications is switched to a parallel display of third and fourth screens corresponding to third and fourth applications, in response to a single external input.

According to another embodiment of the present disclosure, there is proposed a non-transitory computer-readable storage medium having a program stored therein, the program making a computer function as an activation unit to activate multiple applications in response to an external input, an image generation unit to generate multiple screens corresponding to the multiple applications, and a display control unit to perform such a control that the multiple screens generated by the image generation unit are displayed in parallel on a display screen. The display control unit performs such a control that a parallel display of first and second screens corresponding to first and second applications is switched to a parallel display of third and fourth screens corresponding to third and fourth applications, in response to a single external input.

According to an embodiment of the present disclosure, there is proposed a control method including activating multiple applications in response to an external input, generating multiple screens corresponding to the multiple applications, performing such a control that the multiple screens generated are sent to a user terminal, and are displayed in parallel on a display screen of the user terminal, and performing, with a processor, such a control that a parallel display of first and second screens displayed on the display screen and corresponding to first and second applications is switched to a parallel display of third and fourth screens corresponding to third and fourth applications, in response to a single external input.

### Advantageous Effects of Invention

As described above, according to the present disclosure, it is possible to switch a group of multiple screens corresponding to multiple applications, to a group of multiple screens corresponding to multiple applications that are different.

Here, without being necessarily limited to the above effect, some of effects that are shown in the specification or other effects that can be understood from the specification may be exhibited along with the above effect or instead of the above effect.

### BRIEF DESCRIPTION OF DRAWINGS

[FIG. 1]

FIG. 1 is a diagram for explaining an outline of an information processing apparatus according to an embodiment of the present disclosure.

[FIG. 2]

FIG. 2 is a diagram showing a basic configuration of the information processing apparatus according to the embodiment.

[FIG. 3]

FIG. 3 is a flowchart showing an application set switching process in the information processing apparatus according to the embodiment.

[FIG. 4]

FIG. 4 is a flowchart showing an application set switching process in response to contexts in the information processing apparatus according to the embodiment.

[FIG. 5]

FIG. 5 is a transition diagram showing an example of a screen transition in a full screen display control according to the embodiment.

[FIG. 6]

FIG. 6 is a transition diagram showing an example of a screen transition in a scroll display control according to the embodiment.

[FIG. 7A]

FIG. 7A is a transition diagram showing an example of a screen transition in a display area regulation control for each screen according to the embodiment.

[FIG. 7B]

FIG. 7B is a transition diagram showing an example of a screen transition in a display area regulation control for each screen according to the embodiment.

[FIG. 8]

FIG. 8 is a transition diagram showing an example of a screen transition in a first application addition control to an application set.

[FIG. 9]

FIG. 9 is a transition diagram showing an example of a screen transition in a second application addition control to an application set.

[FIG. 10]

FIG. 10 is a transition diagram showing an example of a screen transition in a first application delete control from an application set.

[FIG. 11]

FIG. 11 is a transition diagram showing an example of a screen transition in a second application delete control from an application set.

[FIG. 12]

FIG. 12 is a transition diagram showing an example of a screen transition in an alteration of an application display order according to the embodiment,

[FIG. 13]

FIG. 13 is a transition diagram showing an example of a screen transition in a switching of application sets according to the embodiment.

[FIG. 14]

FIG. 14 is a transition diagram showing an example of a screen transition in an edit of an application set according to the embodiment.

[FIG. 15]

FIG. 15 is a transition diagram showing an example of a screen transition in a control to register an application to a newly added application set according to the embodiment.

[FIG. 16]

FIG. 16 is a transition diagram showing an example of a screen transition in a rotation display control for a screen according to the embodiment.

[FIG. 17]

FIG. 17 is a diagram showing an example of a multiple-screen display of an identical application according to the embodiment.

[FIG. 18]

FIG. 18 is a diagram showing an example of a coordination operation among multiple screens according to the embodiment.

[FIG. 19]

FIG. 19 is a transition diagram showing an example of a screen transition in a coordination operation among multiple screens according to the embodiment.

[FIG. 20]

FIG. 20 is a block diagram showing a configuration of a server included in a display control system according to another embodiment of the present disclosure.

### DESCRIPTION OF EMBODIMENTS

Hereinafter, preferred embodiments of the present disclosure will be described in detail with reference to the accompanying drawings. In the specification and the drawings, as for constituent elements having a substantially identical function and configuration, identical reference characters are assigned, and thereby repetitive descriptions are omitted.

Descriptions will be made in the following order.
1. Outline of an information processing apparatus according to an embodiment of the present disclosure
2. Basic configuration
3. Operation process
3-1. Application set switching
3-2. Application set switching in response to contexts
4. Exemplary display controls
4-1. Full screen display control
4-2. Scroll display control
4-3. Display area regulation control
4-4. Addition of an application to an application set
4-5. Delete of an application from an application set
4-6. Alteration of an application display order
4-7. Switching of application sets
4-8. Edit of an application set
4-9. Rotation display control for a screen
4-10. Multiple-screen display of an identical application
4-11. Coordination operation among multiple screens
5. Another embodiment
6. Conclusion

### 1. Outline of an Information Processing Apparatus According to an Embodiment of the Present Disclosure

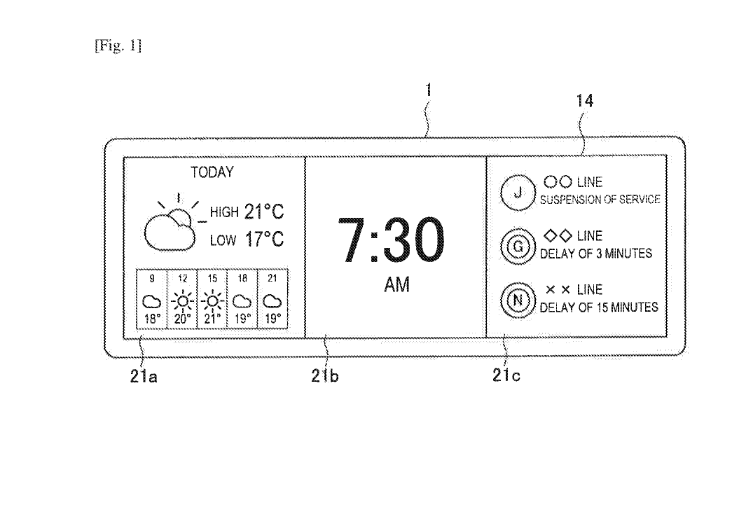

First, an outline of an information processing apparatus according to an embodiment of the present disclosure will he described with reference to FIG. 1. As shown in FIG. 1, an information processing apparatus 1 according to the embodiment is provided with a display unit 14 on one surface. The aspect ratio of the display unit 14 is particularly not limited, and may be 3:1, for example.

On the display unit 14, multiple different application screens can he displayed in parallel. Concretely, as shown in FIG. 1, a screen 21a corresponding to a weather forecast application, a screen 21b corresponding to a watch application and a screen 21c corresponding to a railway information application are displayed in parallel on the display screen of the display unit 14. Further, as shown in FIG. 1, the screens 21a to 21c have the same display area height and display area width, respectively, and the pixel fineness ratio is 1:1 (square pixels).

The display unit 14 according to the embodiment has a touch sensor laminated thereon, and detects a user operation to the display screen.

Here, the display control technique in mobile terminals proposed in the past, which previously assumes about several applications, is not suitable for the simultaneous usage of several tens to several hundreds of applications, which is general in recent mobile terminals such as smart phones. That is, in the multi-window management apparatus disclosed in the above PTL 1, it is difficult to display all the activation icons for several tens to several hundreds of applications on a single screen, and varying the sizes of several tens to several hundreds of windows one by one imposes a heavy burden on a user.

Hence, the embodiment proposes an information processing apparatus that makes it possible to switch a group of multiple windows to another group of multiple windows by one action. Concretely, in FIG. 1, the information processing apparatus 1 can switch all the multiple screens 21a to 21c displayed on the display unit 14, to multiple screens that are different, in response to user's one-action input to the display screen (for example, a swipe operation in the vertical direction perpendicular to the parallel direction).

So far, the outline of the information processing apparatus according to an embodiment of the present disclosure has been described. Subsequently; a configuration and operation processes of the information processing apparatus according to an embodiment of the present disclosure will be described in order.

### 2. Basic Configuration

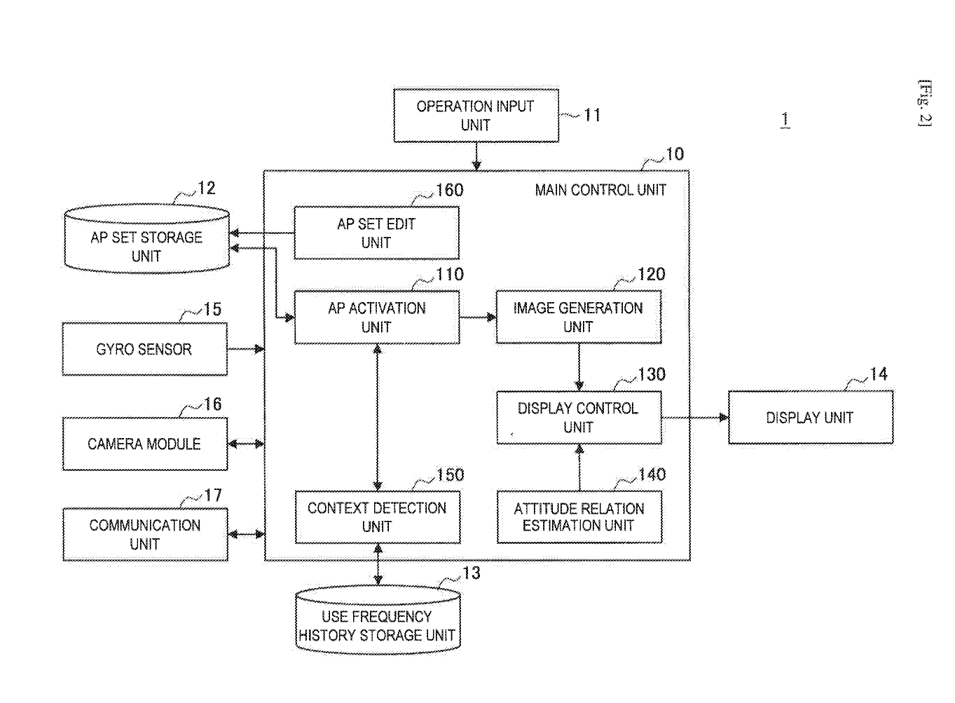

FIG. 2 is a diagram showing a basic configuration of the information processing apparatus 1 according to the embodiment. As shown in FIG. 2, the information processing apparatus 1 includes a main control unit 10, an operation input unit 11, an application set storage unit 12, a use frequency history storage unit 13, the display unit 14, a gyro sensor 15, a camera module 16 and a communication unit 17. In the specification, an application is also referred to as an AP, hereinafter.

### (Main Control Unit)

The main control unit 10 is constituted by a microcomputer including a CPU (Central Processing Unit), a ROM (Read Only Memory), a RAM (Random Access Memory), a nonvolatile memory and an interface unit, for example, and controls each constituent of the information processing apparatus 1, The RAM is used as a working area of the CPU. In the ROM, programs by which the CPU executes each process are written.

As shown in FIG. 2, the main control unit 10 according to the embodiment functions as an AP activation unit 110, an image generation unit 120, a display control unit 130, an attitude relation estimation unit 140, a context detection unit 150 and an AP set edit unit 160.

The AP activation unit 110 activates multiple applications, in response to an external input to the operation input unit 11. For example, the AP activation unit 110 activates three applications of an application set that is previously set, in response to an power-on operation of the information processing apparatus 1. Further, the AP activation unit 110 may activate three applications of another application set, response to a swipe operation perpendicular to the parallel direction of the screens that are displayed on the display screen.

Further, the AP activation unit 110 activates a predetermined number of applications from an appropriate application set, in response to a context (the current period of time, season, day of the week, place, and the like) that is detected by the context detection unit 150 described later. Further, in the case where use frequency histories of applications are stored for each context, the AP activation unit 110 may automatically activate appropriate applications in response to the current context, based on the use frequency histories.

Also, in response to a user operation, the AP activation unit 110 adds a predetermined application to an application set, or deletes a predetermined application from an application set.

The image generation unit 120 generates each of the screens corresponding to the multiple applications that are activated by the AP activation unit 110, and outputs the generated screens to the display control unit 130.

The display control unit 130 performs such a control that the multiple screens generated by the image generation unit 120 are displayed in parallel on the display screen.

In response to a single external input, the display control unit 130 performs such a control that the parallel display of first and second screens corresponding to first and second applications is switched to the parallel display of third and fourth screens corresponding to third and fourth applications. The third and fourth applications may be previously activated in the background by the AP activation unit 110, or may be activated at the time of an occurrence of the single external input. Examples of the above single external input include a single external gesture action (a flick operation, a hover operation, a swipe operation or the like).

The first and second applications and the third and fourth applications belong to different application sets from each other, That is, in response to a single external gesture action, the display control unit 130 can switch the screens of multiple applications belonging to an application set, to the screens of multiple applications belonging to another application set. Thereby, it is possible to switch all the multiple applications by a single gesture action, even when using several tens to several hundreds of applications, and therefore, it is possible to remarkably save the effort of operation, compared to the case of performing the switching operation of the applications one by one.

As shown in FIG. 1, the display control unit 130 sets the screens of the multiple applications displayed on the display unit 14 as square pixels. Thereby, when rotating each screen in response to an attitude relation that is estimated by the attitude relation estimation unit 140 described later, the display control unit 130 can rotate it without changing the screen size.

Further, the display control unit 130 performs various display controls such as a screen switching, in response to a single external input. Various display controls by the display control unit 130 will be explained in detail in “4. Exemplary display controls” described later.

The attitude relation estimation unit 140 estimates a relative attitude relation between the display screen and a viewing user, and outputs the estimated result to the display control unit 130. Concretely, the attitude relation estimation unit 140 recognizes the orientation of the display unit 14 (the attitude of the information processing apparatus 1) based on the information detected from the gyro sensor 15, and further recognizes the orientation of the face of the viewing user (the attitude of the user) based on a pickup image acquired from the camera module 16. Then, the attitude relation estimation unit 140 estimates the relative attitude relation between the display unit 14 and the viewing user, based on the recognized results of the orientation of the display unit 14 (the attitude of the information processing apparatus 1) and the orientation of the face of the viewing user (the attitude of the user). Thereby, even when the viewing user changes the orientation of the information processing apparatus 1, or is viewing it while lying down, the screen is displayed in an appropriate orientation, and the stress of the user is reduced.

The context detection unit 150 detects current contexts, and outputs them to the AP activation unit 110. Concretely, the context detection unit 150 detects the current time, period of time, day of the week, place (current location), season, and the like. The detection of the current location, for example, using a GPS (Global Positioning System) position-measurement unit (not shown in the figure), is performed by receiving electric waves from GPS satellites and measuring the position (current position) where the information processing apparatus 1 is present.

The context detection unit 150 stores use frequency histories of applications for each context in the use frequency history storage unit 13. Thereby, the context detection unit 150 can output the use frequency of each application in response to the detected current context, to the AP activation unit 110, and the AP activation unit 110 can preferentially activate multiple applications with a high use frequency.

The AP set edit unit 160 edits application sets in response to a user operation input from the operation input unit 11. Concretely, the AP set edit unit 160 performs an addition or deletion of an application set stored in the AP set storage unit 12, an alteration of a set name, an alteration of the display order of application sets, and the like.

### (Operation Input Unit 11)

The operation input unit 11 has a function to detect an external input. The operation input unit 11 outputs the detected external input to the AP activation unit 110 and the AP set edit unit 160.

The operation input unit 11 can be implemented in the touch sensor laminated on the display unit 14, as well as a button or switch having a physical structure, such as a power button or a volume control button. In response to the contact information from the touch sensor, the operation input unit 11 can recognize a user operation such as a flick operation, a tap operation, a swipe operation, or a drag-and-drop operation.

### (AP Set Storage Unit)

The AP set storage unit 12 is a storage medium to store application sets by which multiple applications are grouped. Multiple applications that belong to an application set may be arbitrarily set by a user, or multiple applications to be simultaneously used in the same period of time, day of the week, place and the like may he automatically set in response to the use frequencies of the applications for each context.

### (Use Frequency History Storage Unit)

The use frequency history storage unit 13 is a storage medium to store the use frequencies of the applications for each context. Concretely, the use frequency history storage unit 13 stores applications that are being displayed on the display unit 14 and are being used by a user, for each current context (time, period of time, day of the week, place (current location), season and the like) detected by the context detection unit 150.

### (Display Unit)

The display unit 14 is implemented in a display device such as a liquid crystal display (LCD) device and an OILED (Organic Light Emitting Diode) device, for example.

### (Gyro Sensor)

The gyro sensor 15 has a function to detect, when the information processing apparatus 1 is being turned, the velocity (angular velocity) at which the rotation angle around the Z-axis changes, and the angular velocity around the Y-axis, In addition to the gyro sensor 15, the information processing apparatus 1 may include a three-axis acceleration sensor that has a function to detect the acceleration along the X-axis, the acceleration along the Y-axis and the acceleration along the Z-axis as voltage values, respectively.

### (Camera Module)

The camera module 16 is a signal conversion unit such as a CCD (Charge Coupled

Device) or a CMOS (Complementary Metal Oxide Semiconductor), and an object image is formed by an optical system. The optical system includes, as image pickup lenses, an in-camera lens that is provided on the same face (front face) as the display unit 14 and picks up an image of a viewing user, and a back-face camera lens that is provided on the opposite face (reverse face) to the display unit 14 and is oriented outward.

### (Communication Unit)

The communication unit 17 has a function to connect with an external apparatus by wire/wireless and to perform the sending and receiving of data. For example, the communication unit 17 can connect with a wireless AP (access point) by a wireless LAN, infrared rays, Wi-Fi (R) or the like, and can connect with a network through the wireless AR Then, from a predetermined server in the network, the communication unit 17 can acquire display data of a web browser, and programs that constitute the software for executing a series of processes according to the embodiment.

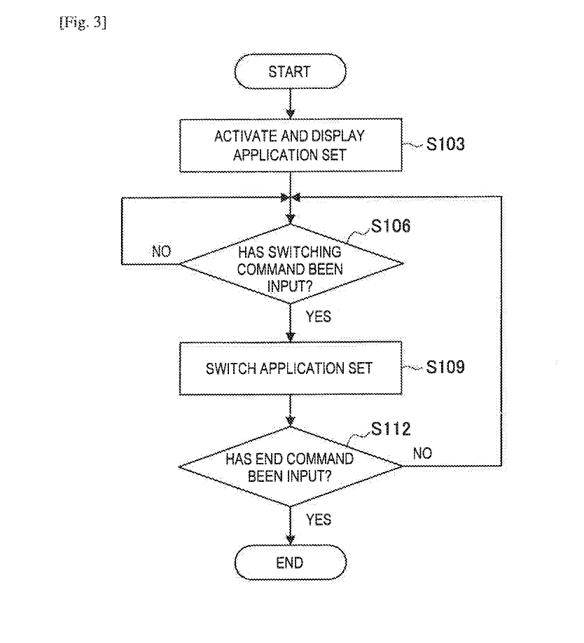

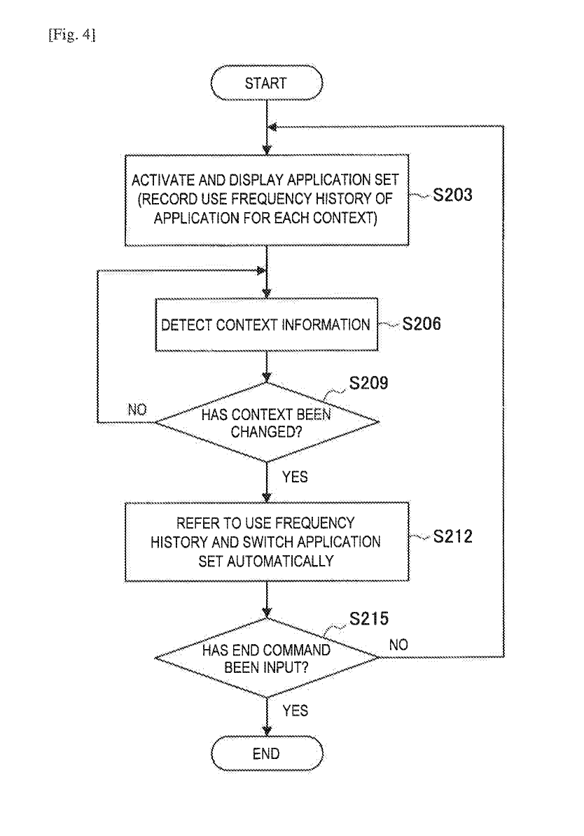

So far, the configuration of the information processing apparatus 1 according to the embodiment has been concretely described. Although not shown in FIG. 2, the information processing apparatus 1 according to the embodiment further includes a microphone, a speaker, and a storage medium to store various data such as images (pictures, videos) and application programs. Subsequently, a typical display control process in the information processing apparatus 1 according to the embodiment will be concretely described with reference to FIG. 3 and FIG. 4.

### 3. Operation Process

### 3-1. Application Set Switching

FIG. 3 is a flowchart showing an application set switching process in the information processing apparatus 1 according to the embodiment. As shown in FIG. 3, first, in step S103, once the information processing apparatus 1 is powered on, the AP activation unit 110 activates multiple applications that belong to an application set.

Then, the image generation unit 120 generates multiple screens respectively corresponding to the multiple applications, and they are arrayed in parallel and displayed on the display unit 14 by the display control unit 130.

Next, in step S106, the main control unit 10 waits for an input of a switching command that instructs to switch the application set. The switching command may be, for example, a two-finger swipe operation perpendicular to the parallel direction of the screens displayed on the display screen.

Next, if the switching command is input from the operation input unit 11 (S106/Yes), in step S109, the display control unit 130 switches the application set. Concretely, the display control unit 130 switches all the multiple screens corresponding to the multiple applications that belong to the first application set, to multiple screens corresponding to multiple applications that belong to a second application set.

Then, the above S106 to S109 are repeated until an end command is input in step S112.

### 3-2. Application Set Switching in Response to Contexts

Although the above described application set switching is triggered by an input of the switching command that is a single external input, the embodiment is not limited to this, and for example, the display control unit 130 can perform a switching to an appropriate application set in response to contexts. In the following, concrete descriptions will be made with reference to FIG. 4.

FIG. 4 is a flowchart showing an application set switching process in response to contexts in the information processing apparatus 1 according to the embodiment. As shown in FIG. 4, in step S203, the AP activation unit 110 activates multiple applications that belong to an application set. Then, the image generation unit 120 generates multiple screens respectively corresponding to the multiple applications, and they are arrayed in parallel and displayed on the display unit 14 by the display control unit 130. As shown in FIG. 3, the application set activated and displayed at this time is switched to another application set, in response to an input of the switching command.

When the AP activation unit 110 activates the multiple applications, the context detection unit 150 detects current contexts (time, day of the week, place and the like), and stores them in relation to applications that are currently being used. Thereby, the use frequency histories of the applications are recorded for each context.

Next, in step S206, the context detection unit 150 continuously detects context information. The detection of contexts is repeated periodically/non-periodically.

Next, in step S209, the AP activation unit 110 judges whether the contexts detected by the context detection unit 150 have been changed. For example, the AP activation unit 110 judges the change in period of time (morning, daytime, evening), the change in day of the week, the change in place (current location) and the like, based on the contexts continuously detected by the context detection unit 150.

Next, if a context has been changed (S209/Yes), in step S212, the AP activation unit 110 refers to the use frequency histories of the applications for each context, and performs a switching to an appropriate application set in response to the current context. For example, in the case where the morning period has been changed to the daytime period, the AP activation unit 110 activates multiple applications that belong to an application set having a high use frequency in the daytime period.

Then, the above S203 to S212 are repeated until an end command is input in step S215.

Thus, in response to the current period of time, day of the week, place or the like, the information processing apparatus 1 according to the embodiment performs the automatic switching to an application set that a user uses at a high frequency in the period of time, day of the week, place or the like, and thereby, can improve the convenience.

So far, the application set switching has been described as a typical display control process of the information processing apparatus 1 according to the embodiment.

The display control of the information processing apparatus 1 according to the embodiment is not limited to the switching control of the application set, and controls such as the display switching of multiple applications that belong to an application set, the expansion/shrinkage of the display area, the addition/deletion, and the alternation of the display order are also possible. In the following, such various display controls according to the embodiment will be concretely described with transition diagrams each of which shows an example of screens to be displayed on the display unit 14.

### 4. Exemplary Display Controls

### 4-1. Full Screen Display Control

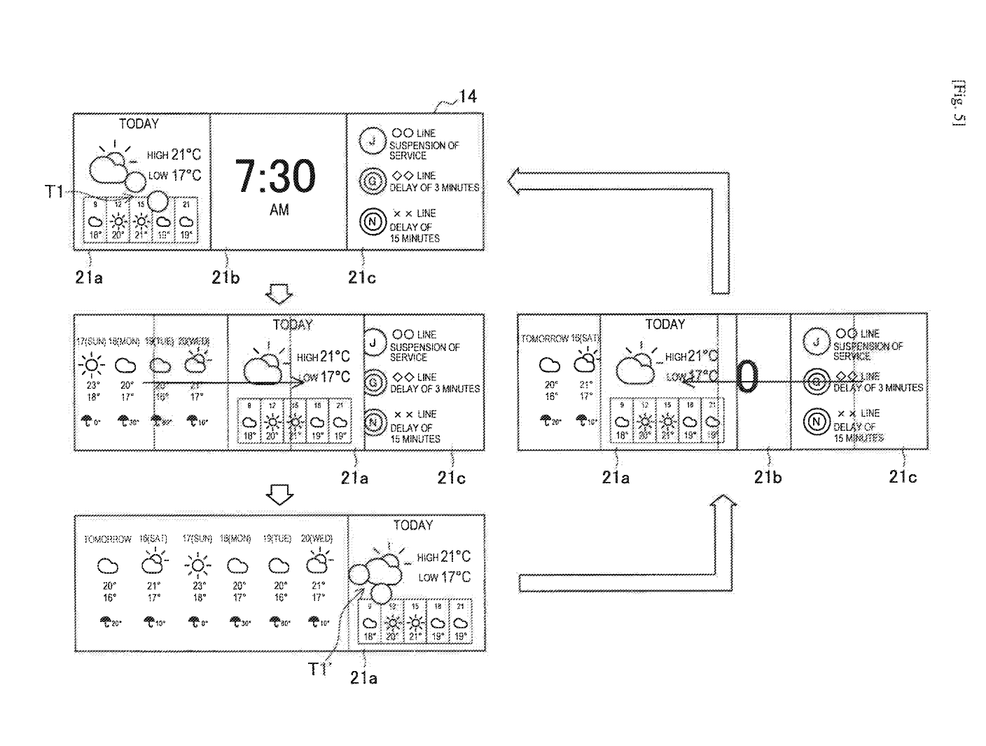

First, a full screen display control will be described with reference to FIG. 5. FIG. 5 is a transition diagram showing an example of a screen transition in a full screen display control according to the embodiment. As shown in FIG. 5, when the multiple screens 21a, 21b, 21c are displayed in parallel on the display unit 14, in response to a two-finger tap operation T1 in the display area of the screen 21a by a user, the display control unit 130 expands the display area of the screen 21a to display it on the full screen of the display unit 14. That is, since the screen 21a is a screen corresponding to the weather forecast application, the screen 21a corresponding to the weather forecast application is displayed on the full screen of the display unit 14, as shown in FIG. 5.

Further, once a two-finger tap operation T1 is performed in the state of the full screen display, the display area of the screen 21a is shrunk and the former three division screen (the parallel display screen of the screens 21a, 21b, 21c) is restored.

Thus, in the case where the display screen is divided and multiple applications are simultaneously used, a user can display, on the full screen, a screen corresponding to one intended application, by one action.

### 4-2. Scroll Display Control

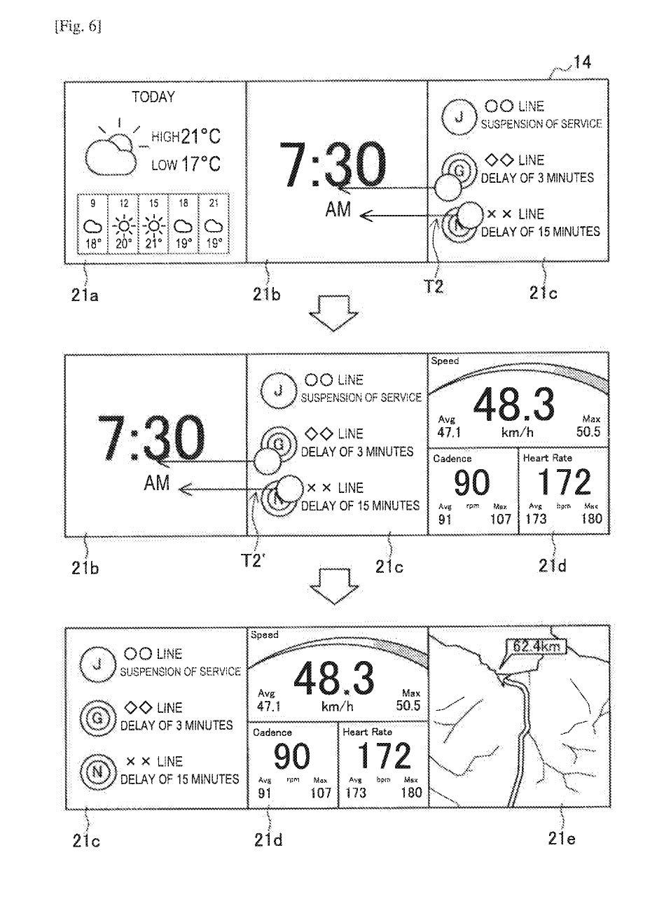

Next, a scroll display control will be described with reference to FIG. 6. FIG. 6 is a transition diagram showing an example of a screen transition in a scroll display control according to the embodiment. In the case where the screens 21a, 21b, 21c displayed on the display unit 14 shown in FIG. 6 are of the multiple applications that belong to an identical application set, the information processing apparatus 1 can scroll and display other applications that are not being displayed on the screen.

For example, as shown in FIG. 6, in response to two-finger swipe operations T2, T2′ in the lateral direction (parallel direction), the display control unit 130 moves the screens 21a to 21c in the lateral direction, and sequentially displays screens 21d, 21e corresponding to other applications that belong to the identical application set.

Thus, even when all the screens corresponding to the multiple applications that belong to an identical application set are not displayed on the display unit 14, the scroll display is possible by one action, and a user can view many applications with less effort of operation.

### 4-3. Display Area Regulation Control

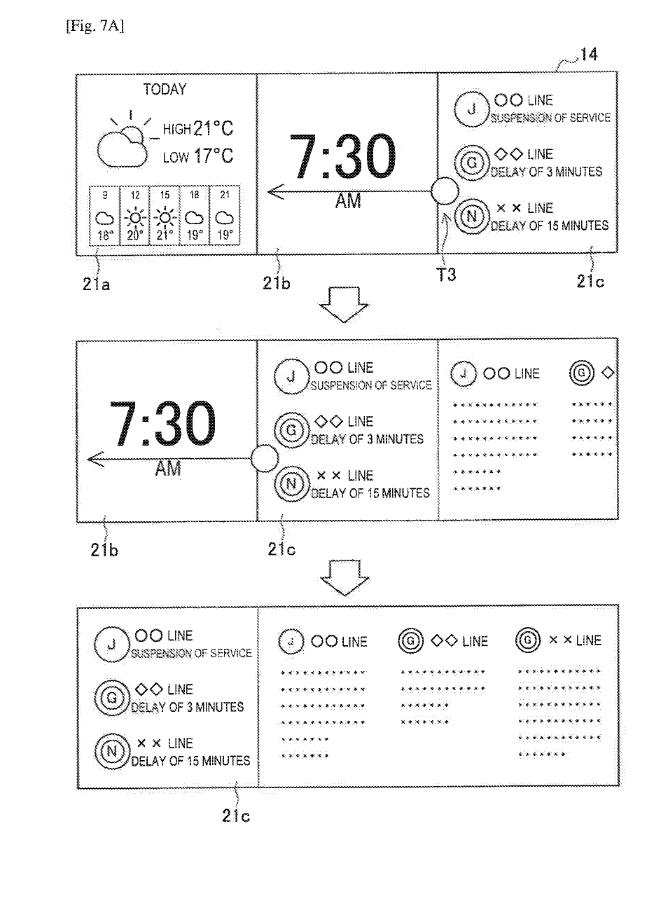

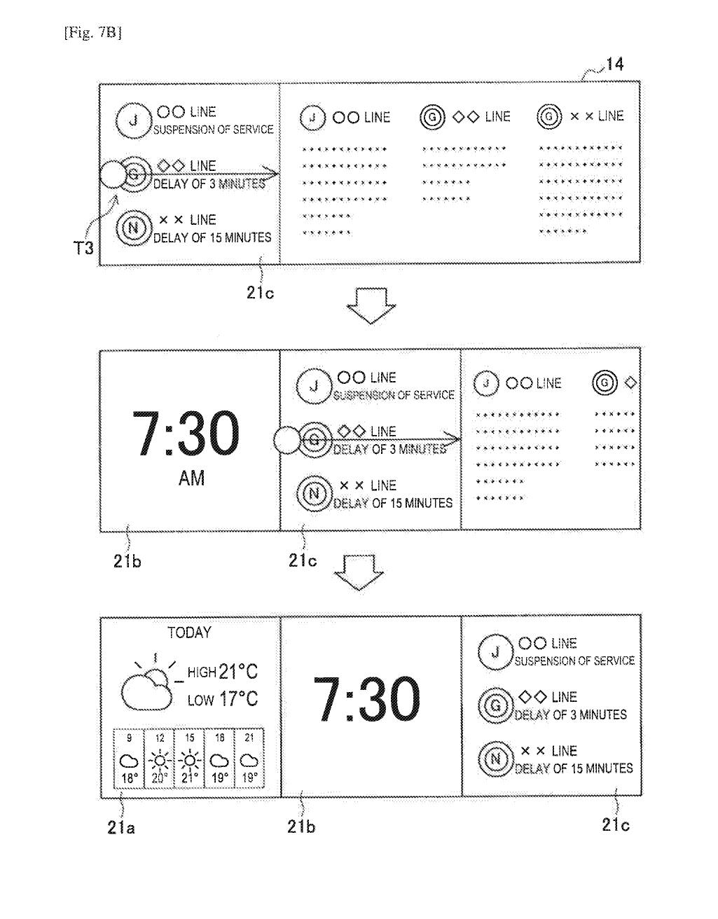

Next, a display area regulation control will be described with reference to FIG. 7. FIG. 7A and FIG. 713 are transition diagrams each of which shows an example of a screen transition in a display area regulation control for each screen according to the embodiment. As Shown in FIG. 7A, in the initial state, the display screen is divided into three, and the multiple screens 21a, 21b, 21c are displayed in a square pixel manner. However, a user can arbitrarily alter the display area of each screen.

For example, as shown in FIG. 7A, when the multiple screens 21a, 21b, 21c are displayed in parallel on the display unit 14, in response to a leftward drag operation T3 in which the start point is on the left-side border line of the screen 21c positioned at the right end of the display screen, the display control unit 130 expands the display area of the screen 21c.

On the other hand, when shrinking back the expanded screen 21c, as shown in FIG. 7B, in response to a rightward drag operation T3 in which the start point is on the left-side border line of the expanded screen 21c, the display control unit 130 shrinks the display area of the screen 21c.

Thus, the display control unit 130 according to the embodiment can expand/shrink in the parallel direction the display area of one screen of the multiple screens displayed in parallel, in response to a drag operation input in the parallel direction in the vicinity of a border line of the one screen.

### 4-4. Addition of an Application to an Application Set

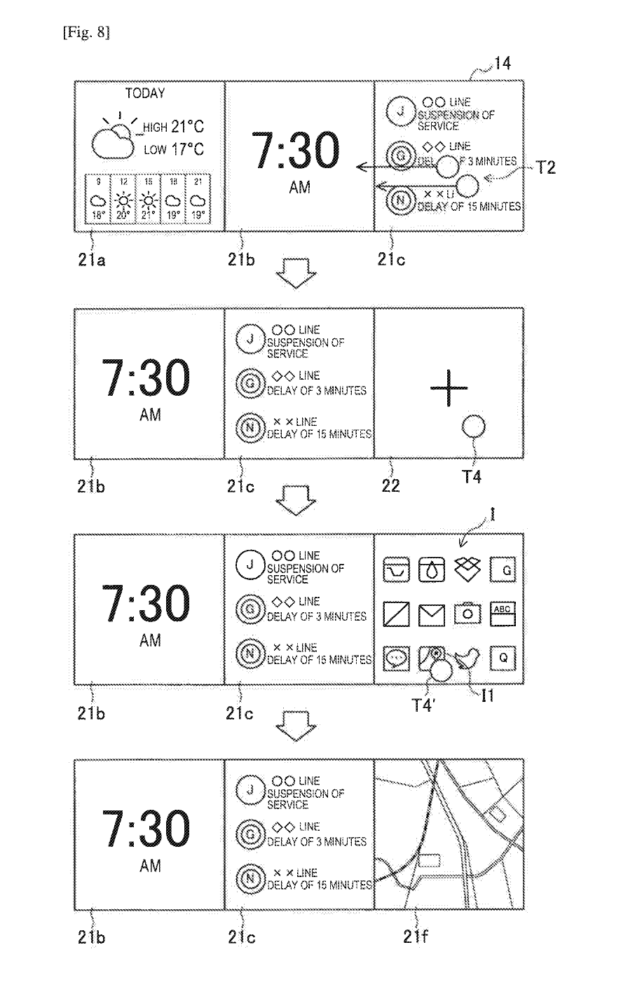

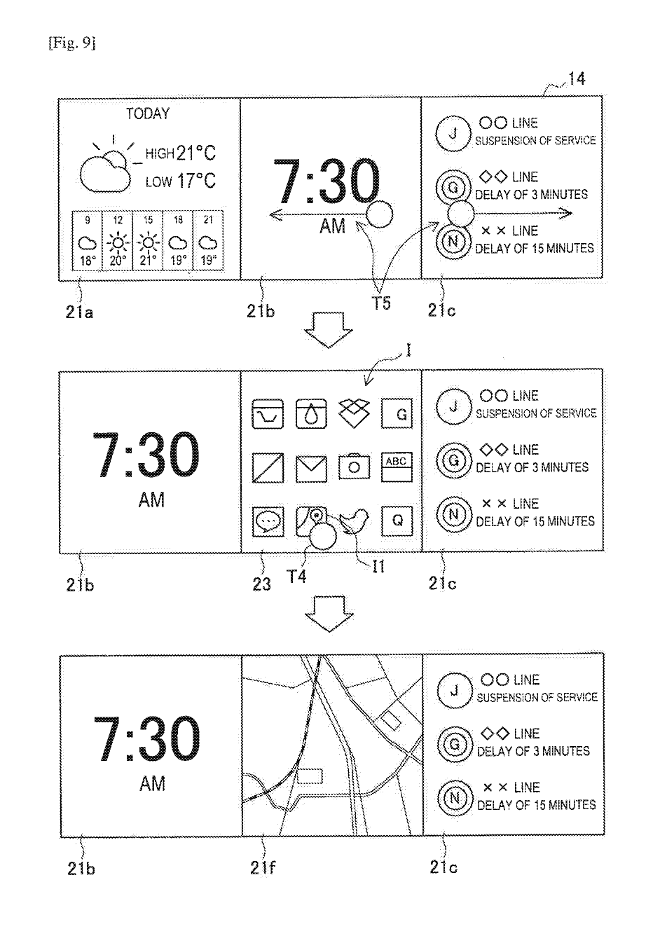

Next, an addition of an application to an application set will be described with reference to FIG. 8 and FIG. 9.

FIG. 8 is a transition diagram showing an example of a screen transition in a first application addition control to an application set. When the multiple screens 21a to 21c are displayed in parallel on the display unit 14 as shown in the top of FIG. 8, in response to an input of a leftward swipe operation T2, the display control unit 130 scrolls the screens, and sequentially displays multiple screens that belong to the identical application set. When the multiple screens have been scrolled to the end of the application set, the display control unit 130 displays an addition screen 22 for an application.

Next, once a tap operation T4 is performed in the display area of the addition screen 22, the display control unit 130 displays a list I of icons corresponding to the applications that are currently installed in the information processing apparatus 1. Once a user selects an arbitrary icon I1 (for example, an icon for a map application) from the list I of the icons by performing a tap operation T4′, the activation unit 110 of the information processing apparatus 1 adds the application for the selected icon I1, to the application set. Then, the display control unit 130 replaces a screen 21f corresponding to the added application with the addition screen 22, and displays it at the end of the multiple screens corresponding to the multiple applications that belong to the application set.

So far, the application addition control has been described. The application addition control according to the embodiment is not limited to the example shown in FIG. 8, and for example, may be an addition control described next.

FIG. 9 is a transition diagram showing an example of a screen transition in a second application addition control to an application set. When the multiple screens 21a to 21c are displayed in parallel on the display unit 14 as shown in the top of FIG. 9, a user performs a pinch-out operation T5 so as to separate the two screens 21b, 21c adjacent at a position where an addition of an application is intended. Concretely, in a state in which one finger is placed in the display area of the screen 21b and another finger is placed in the display area of the screen 21c adjacent to the screen 21b, the pinch-out operation T5 is performed such that the fingers depart from each other.

In response to the pinch-out operation T5, the display control unit 130 separates the display positions of the screen 21b and screen 21c to left and right, and newly displays an addition screen 23 for an application, between the screen 21b and the screen 21c.

On the addition screen 23, the list I of the icons corresponding to the applications that are currently installed in the information processing apparatus 1 is displayed. From the list I of the icons, a user selects an icon for an application that is intended to be added, by performing a tap.

For example, once the tap operation T4 is performed to the icon I1 for the map application, the activation unit 110 of the information processing apparatus 1 adds the application for the selected icon I1, to the application set. Then, the display control unit 130 replaces the screen 21f corresponding to the added application with the addition screen 23, and displays it between the screen 21b and the screen 21c.

### 4-5. Deletion of an Application From an Application Set

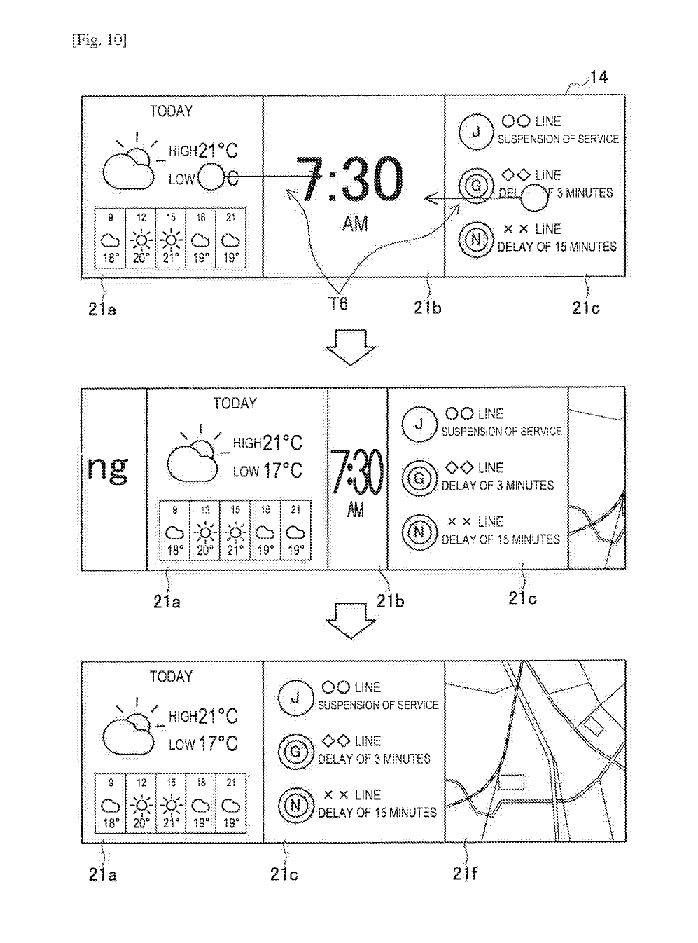

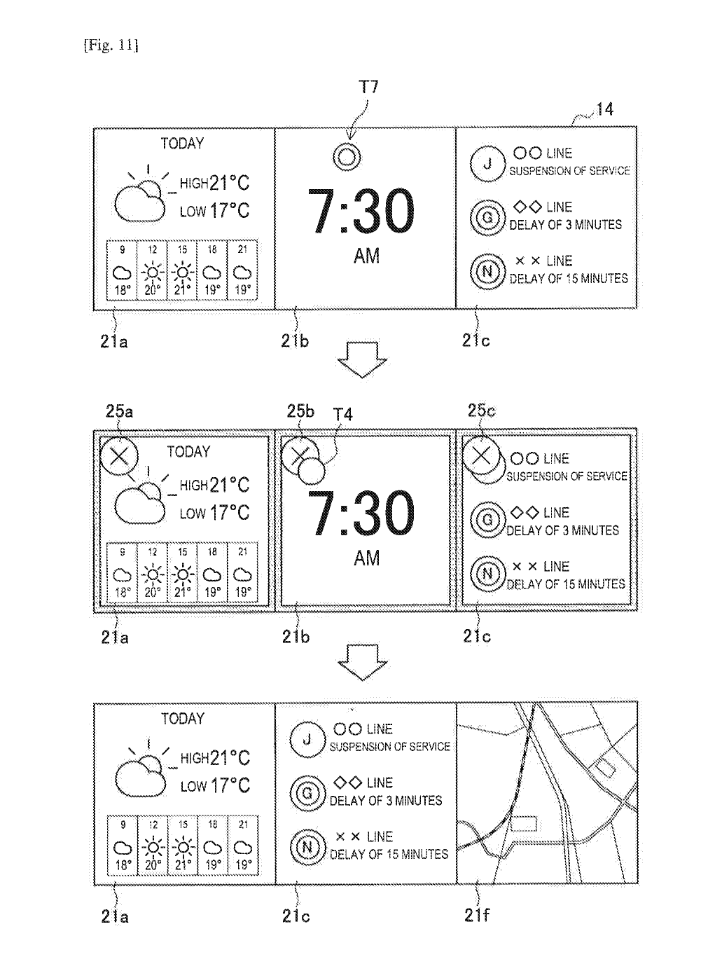

Next, a deletion of an application from an application set will be described with reference to FIG. 10 and FIG. 11.

FIG. 10 is a transition diagram showing an example of a screen transition in a first application deletion control from an application set. When the multiple screens 21a to 21c are displayed in parallel on the display unit 14 as shown in the top of FIG. 10, a user performs a pinch-in operation T6 so as to bring the two screens 21a, 21c close to each other, which are displayed at positions sandwiching the screen 21b that is intended to be deleted. Concretely, in a state in which one finger is placed in the display area of the screen 21a and another finger is placed in the display area of the screen 21c, the pinch-in operation T6 is performed such that the fingers are brought close to each other.

In response to the pinch-in operation T6, the display control unit 130 brings the display positions of the screen 21a and screen 21c close to each other while shrinking the display area of the screen 21b that is displayed between the screen 21a and the screen 21c, and eventually performs such a control that it is hidden. Thereby, on the display unit 14, the screen 21b is removed, and the multiple screens 21a, 21c, 21f that belong to the identical application set are displayed. Further, the activation unit 110 deletes the application corresponding to the screen 21b that has been controlled to be hidden, from the application set.

So far, the application deletion control has been described. The application deletion control according to the embodiment is not limited to the example shown in FIG. 10, and for example, may be a deletion control described next.

FIG. 11 is a transition diagram showing an example of a screen transition in a second application deletion control from an application set. When the multiple screens 21a to 21c are displayed in parallel on the display unit 14 as shown in the top of FIG. 11, a user performs a long-press operation T7 on any screen.

In response to the long-press operation T7, the display control unit 130 displays delete buttons 25a to 25c on the multiple screens 21a to 21c displayed in parallel, respectively, and performs such a control that the screen 21b corresponding to a delete button selected by a tap operation T4 is hidden. Thereby; on the display unit 14, the screen 21b is removed, and the multiple screens 21a, 21c, 21f that belong to the identical application set are displayed. Further, the activation unit 110 deletes the application corresponding to the screen 21b that has been controlled to be hidden, from the application set.

### 4-6. Alteration of an Application Display Order

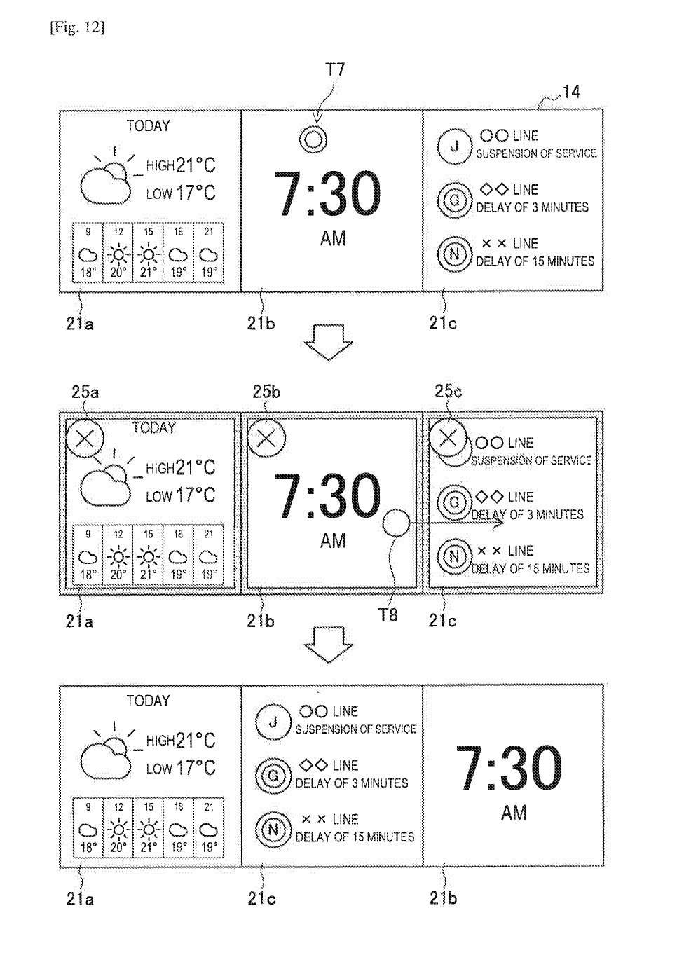

Next, an alternation of an application display order will be described with reference to FIG. 12. FIG. 12 is a transition diagram showing an example of a screen transition in an alteration of an application display order according to the embodiment. As shown in FIG. 12, when the multiple screens 21a, 21b, 21c, in the order from the left end, are displayed in parallel on the display unit 14, a user performs a long-press operation T7 on any screen.

After the long-press operation, a user performs a drag operation T8 in the parallel direction (the rightward direction or the leftward direction) for the screen 21b, whose display order is intended to be altered, in response to the drag operation T8, the display control unit 130 interchanges the display position of the screen 21b displayed at the drag operation start position, with the display position of the screen 21c displayed at the drag operation end position so that the screens 21a, 21c, 21b, in the order from the left end, are displayed in parallel.

Thus, the display control unit 130 according to the embodiment can alter the display position (display order) of each screen, in response to the drag operation input by a user.

### 4-7. Switching of Application Sets

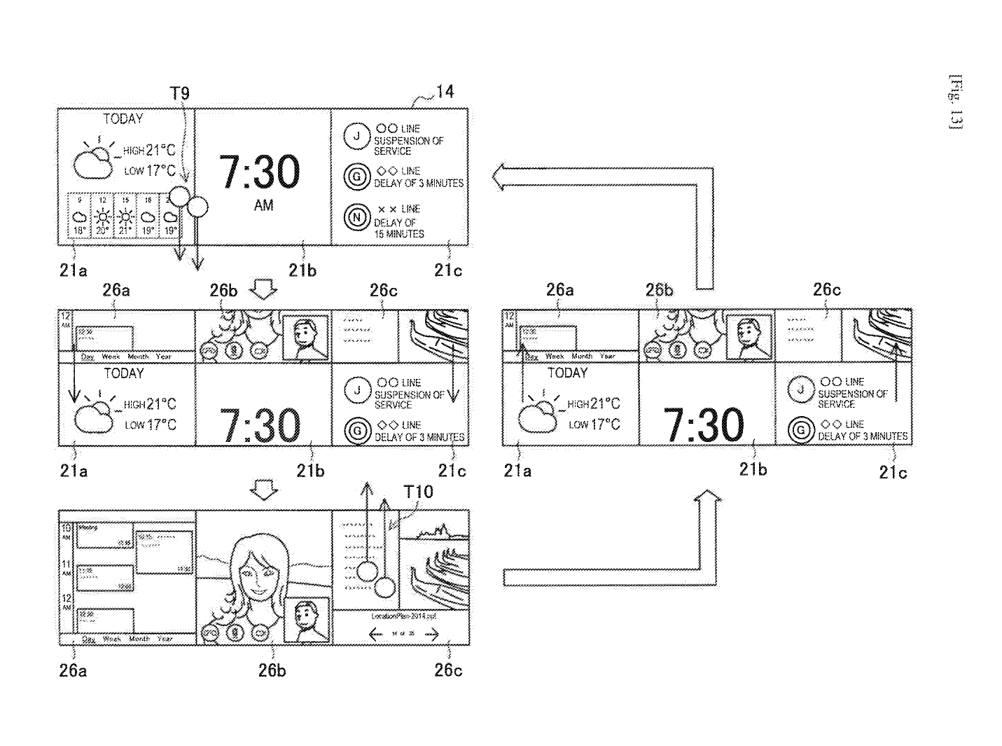

Next, a switching of application sets will be described with reference to FIG. 13. FIG. 13 is a transition diagram showing an example of a screen transition in a switching of application sets according to the embodiment. As shown in FIG. 13, when the multiple screens 21a to 21c corresponding to the multiple applications that belong to the identical application set are displayed in parallel on the display unit 14, a user performs a two-finger swipe operation T9 in the direction (the vertical direction) perpendicular to the parallel direction.

In response to the swipe operation T9, the display control unit 130 switches all the multiple screen displays corresponding to the multiple applications that belong to the first application set, to multiple screen displays corresponding to multiple applications that belong to a second application set. Concretely, as shown in FIG. 13, in response to the swipe operation T9, all the screens 21a to 21c are moved in the vertical direction and scrolled out, and multiple screens 26a to 26c corresponding to multiple applications that belong to the next application set are newly scrolled in.

Thus, it is possible to switch multiple screens corresponding to multiple applications on an application set basis, by a single input, and it is possible to save the effort of operation.

By carrying on the swipe operation T9 in the vertical direction, a user can make multiple application sets displayed sequentially.

When the display of the application set is restored, as shown in FIG. 13, by performing a two-finger swipe operation T9 in the upward direction, which is opposite to the swipe operation T9 in the downward direction, it is possible to display the screens 21a to 21c for the last application set.

Also, the switching of application sets can be automatically performed. Concretely, as described above with reference to FIG. 4, when getting to a specific time, or when reaching a specific place, the display control unit 130 performs a switching to an appropriate application set. The appropriate application set may be previously set corresponding to the specific time, place or the like, or may be based on the use frequency histories for each context.

Here, the context to be detected by the context detection unit 150 is not limited to a time, a place and the like, and may be a specific behavior situation of a user based on detection results by various sensors. The specific behavior situation of a user is, for example, a behavior situation in which he/she is riding a bicycle, in which he/she is driving a car, in which he/she is walking, or the like. Thereby, for example, in the case where a user is riding a bicycle, the display control unit 130 can perform a switching to an application set for applications that can be used when the user is riding a bicycle, such as a cyclemeter application and a navigation application.

### 4-8. Edit of an Application Set

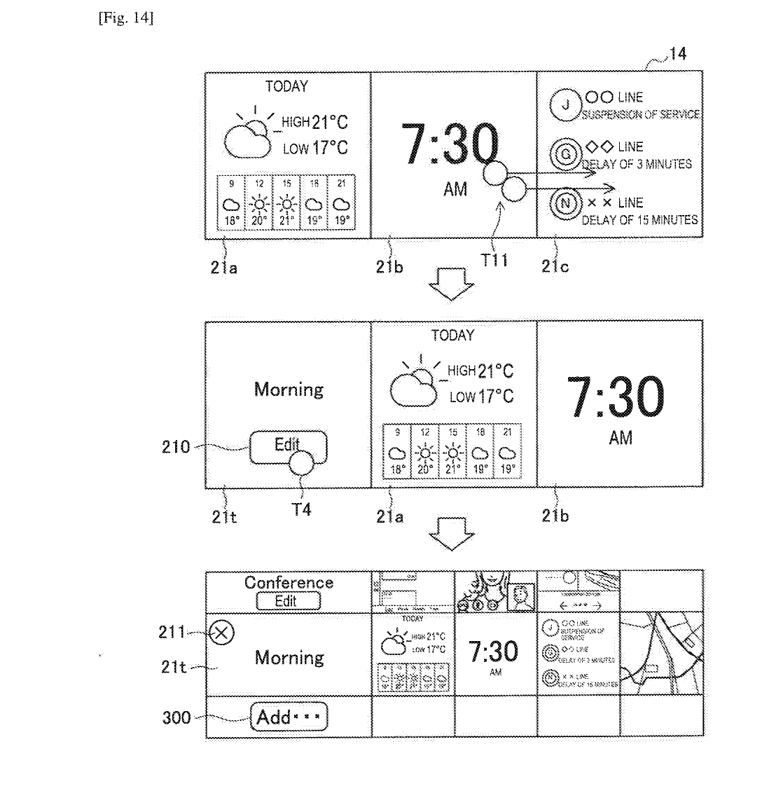

Next, an edit of an application set will be described with reference to FIG. 14. FIG. 14 is a transition diagram showing an example of a screen transition in an edit of an application set according to the embodiment. As shown in FIG. 14, when the multiple screens 21a to 21c are displayed in parallel on the display unit 14, in response to an input of a rightward swipe operation T11, the display control unit 130 scrolls the screens and sequentially displays multiple screens that belong to the identical application set. When the multiple screens have been scrolled to the head of the application set, the display control unit 130 displays an edit screen 21t for the applications. On the edit screen 21t, the application set name and an edit button 210 are displayed.

A tap operation T4 to the edit button 210 by a user leads to an application set edit mode. Concretely, as shown in the bottom of FIG. 14, multiple application sets are shrunk and displayed, and a user can tap an application set name to alter the set name, or can tap a delete button 211 to delete the application set. Also, a user can tap an addition button 300 to newly add an application set. Further, by performing an upward or downward swipe operation, it is possible to view multiple application sets, and by performing an upward or downward drag operation, it is possible to alter the display order of the application sets.

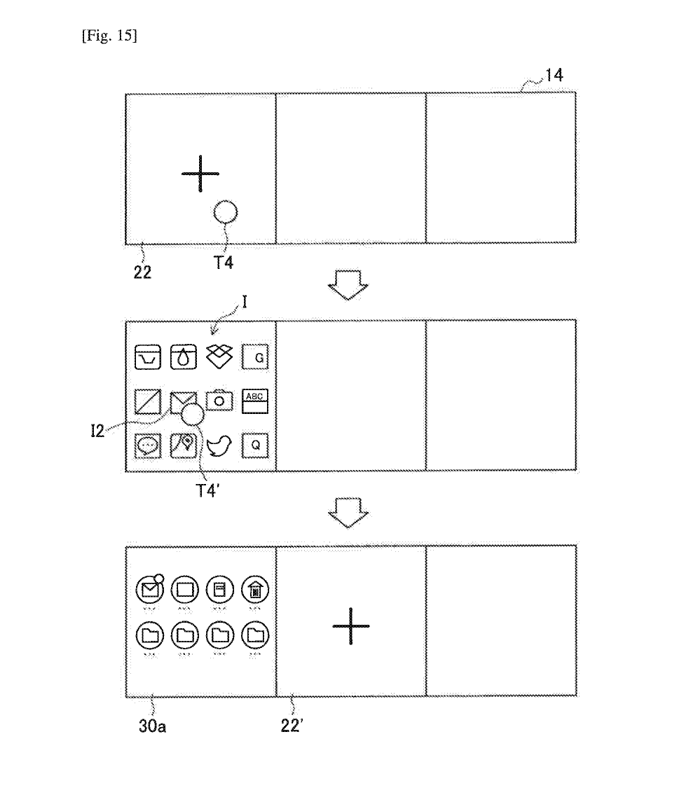

Here, an addition of an application in the case of newly adding an application set will be described with reference to FIG. 15. FIG. 15 is a transition diagram showing an example of a screen transition in a control to register an application to a newly added application set according to the embodiment. As shown in the top of FIG. 15, the initial state after an application set is added is an empty state in which no application has been registered. On this occasion, the display control unit 130 displays an addition screen 22 on the left end of the display unit 14, and in response to a tap operation T4 to the addition screen by a user, displays the list I of the icons that are currently installed in the information processing apparatus 1.

Once a user selects an icon I2 from the list I of the icons by a tap operation. T4′, the activation unit 110 adds an application indicated by the icon I2 to the application set, and activates the added application. Then, the display control unit 130 replaces a screen 30a corresponding to the activated application with the addition screen 22, to display it on the left end, and newly displays an addition screen 22′ next to the screen 30a. Thus, in the embodiment, it is possible to add applications sequentially from the head (for example, the left end) of the application set.

### 4-9. Rotation Display Control for a Screen

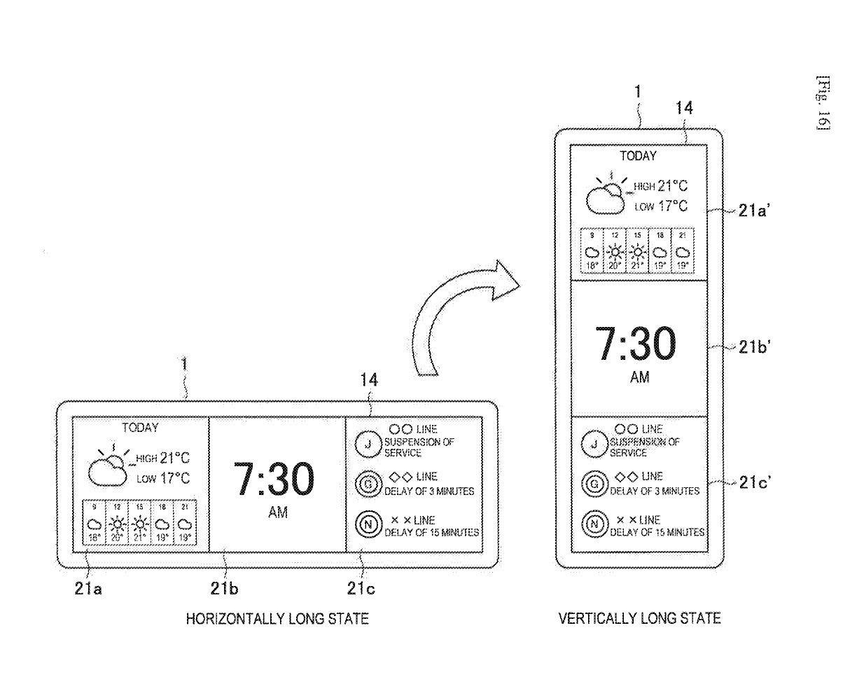

Subsequently, a rotation display control for a screen will be described with reference to FIG. 16. FIG. 16 is a transition diagram showing an example of a screen transition in a rotation display control for a screen according to the embodiment. As shown in the left of FIG. 16, in the case where the information processing apparatus 1 is in a horizontally long state in which the long side of the display unit 14 is horizontal, the multiple screens 21a, 21b, 21c are displayed on the display unit 14 so as to be arrayed laterally in parallel. On this occasion, as described above, the multiple screens 21a to 21c are displayed in a square pixel manner.

Next, as shown in the right of FIG. 16, once the information processing apparatus 1 is rotated so as to be in a vertically long state in which the long side of the display unit 14 is vertical, screens 21a′, 21b′, 21c′, in which the display contents are rotated with the display position relation (parallel display) among the screens 21a to 21c kept (without changing the screen sizes), are displayed.

In the case where the screens 21a′, 21b′, 21c′ are displayed vertically in parallel, the display control unit 130 performs the application set switching described with reference to FIG. 13, in response to a two-finger swipe operation in the lateral direction (in the direction perpendicular to the screen parallel direction).

Thus, in response to the rotation of the information processing apparatus 1 (the display unit 14), the display control unit 130 according to the embodiment can rotate each screen such that the display position of each screen is kept and the screen size is not changed. Here, without being limited to the rotation of the information processing apparatus 1, based on the estimated result by the attitude relation estimation unit 140, the display control unit 130 may judge whether to rotate each screen, in response to the relative attitude relation between the display unit 14 and a viewing user.

### 4-10. Multiple-Screen Display of an Identical Application

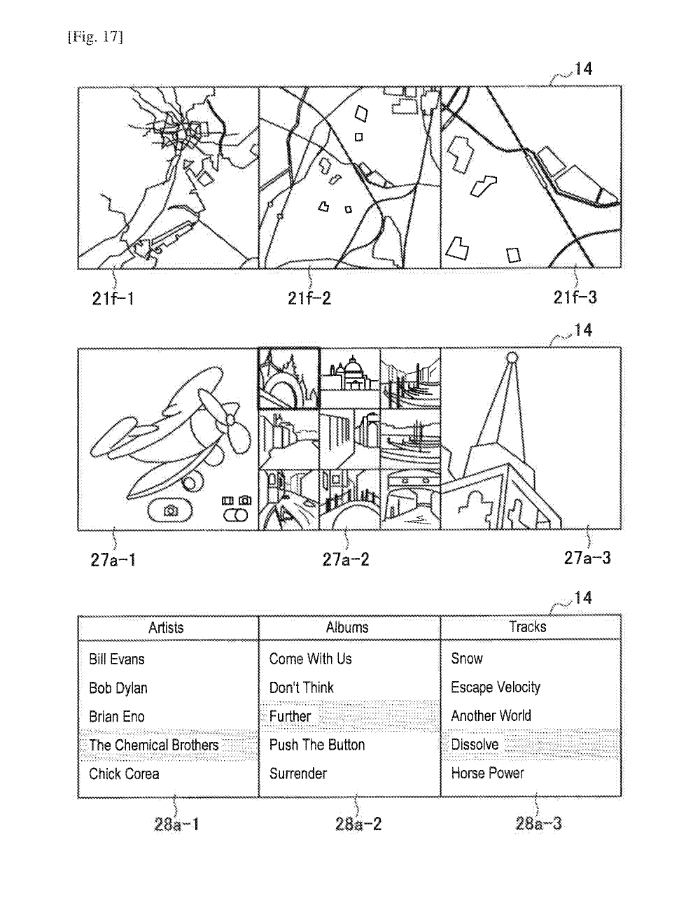

Next, a multiple-screen display of an identical application will be described with reference to FIG. 17. FIG. 17 is a diagram showing an example of a multiple-screen display of an identical application according to the embodiment. In each example shown in FIG. 17, screens corresponding to one application are displayed on the full screen of the display unit 14. On this occasion, the display control unit 130 divides the display unit. 14 into multiple screens to display the identical application on the multiple screens (windows), and thereby, can improve the convenience of application usage.

Concretely, as shown in the top of FIG. 17, multiple screens 21f-1, 21f-2, 21f-3 corresponding to a map application are displayed, and thereby, it is possible to simultaneously display the same point on different scales.

In an example shown in the middle of FIG. 17, multiple screens 27a-1, 27a-2, 27a-3 corresponding to a camera application are displayed, and thereby, it is possible to simultaneously display a camera view at the time of photographing, a thumbnail view of photographed pictures, and an enlarged display view of a picture selected on the thumbnail view.

In an example shown in the bottom of FIG. 17, multiple screens 28a-1, 28a-2, 28a-3 corresponding to a music application are displayed, and thereby, it is possible to simultaneously display a large classification (artist names), middle classification (album names) and small classification (musical composition names) of musical composition data, respectively.

### 4-11. Coordination Operation Among Multiple Screens

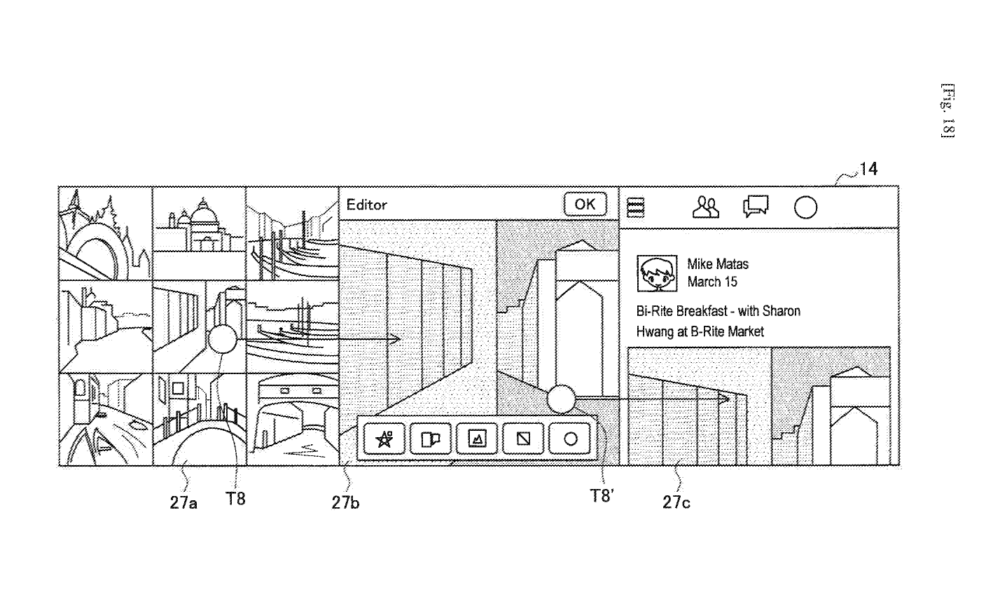

Next, a coordination operation among multiple screens will be described with reference to FIG. 18. FIG. 18 is a diagram showing an example of a coordination operation among multiple screens according to the embodiment. As shown in FIG. 18, in the order from the left, a screen 27a corresponding to a camera application, a screen 27b corresponding to an image edit application, and a screen 27c corresponding to an SNS application are displayed in parallel on the display unit 14.

On this occasion, once a user selects an arbitrary image from the screen 27a and performs a drag-and-drop operation T8 to the area of the screen 27b, the image is transferred to the screen 27b and becomes a processing object of the image edit application. Concretely, in response to the drag-and-drop operation T8 by a user, the AP activation unit 110 transfers the data displayed at the drag start position, to the image edit application corresponding to the drop position, so that it becomes a processing object.

Once a user performs an edit of the image, such as an adjustment of the color tone, on the screen 27b, and further performs a drag-and-drop operation T8 of the edited image to the area of the screen 27c, the edited image is transferred to the screen 27c and becomes a processing object of the SNS application. Concretely, in response to the drag-and-drop operation T8′ by a user, the AP activation unit 110 can transfer the data displayed at the drag start position, to the SNS application corresponding to the drop position, and can share them with other users.

Thus, by performing a drag-and-drop of data such as texts, images or videos that are created in one application, to a screen area corresponding to another application, it is possible to coordinate the data without performing the switching operation of the applications.

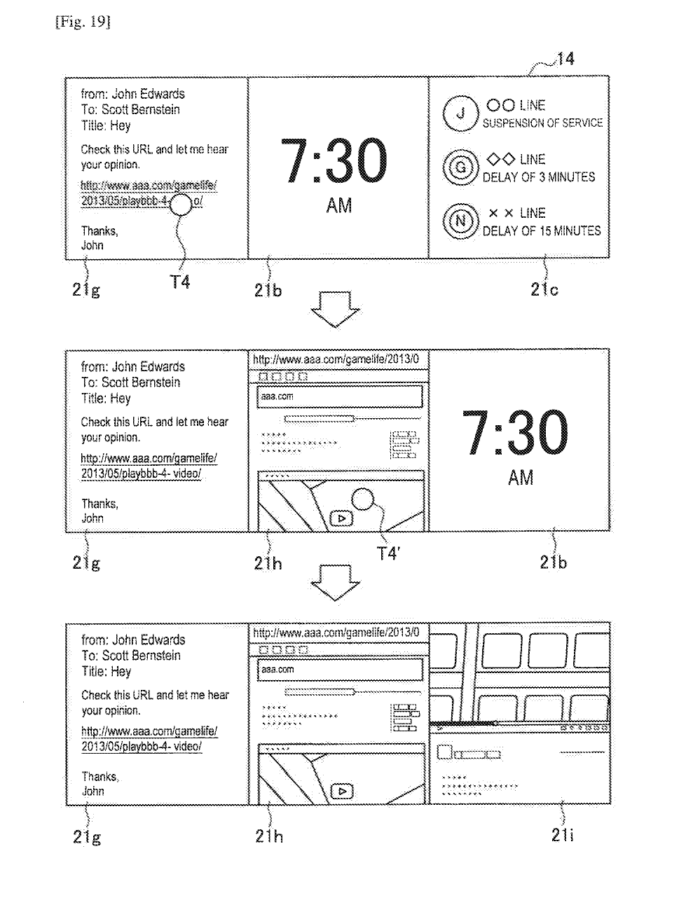

Here, such a coordination operation among multiple screens can be automatically performed in response to an implicit operation with a link, other than an explicit operation such as the drag-and-drop operation by a user. In the following, the description will be made with reference to FIG. 19.

FIG. 19 is a transition diagram showing an example of a screen transition in a coordination operation among multiple screens according to the embodiment. As shown in FIG. 19, a screen 21g corresponding to a mail application, the screen 21b corresponding to the watch application, and the screen 21c corresponding to the railway information application are displayed in parallel on the display unit 14.

On this occasion, once a tap operation 14 is performed to a Web page URL that is contained in a mail text displayed on the screen 21g, a Web browser application is automatically activated by the AP activation unit 110, and a screen 21h corresponding to the Web browser application is displayed. On the screen 21h, a Web page that is indicated by the URL tapped on the screen 21g is opened.

In the case where a moving image is embedded in the Web page opened on the screen 21h, once a tap operation T4′ is performed to the display area of the moving image, a moving image playback application is further activated automatically by the AP activation unit 110, and a screen 21i corresponding to the moving image playback application is displayed. On the screen 21i, the moving image tapped on the screen 21h is played back.

Thus, once a user selects the area of a URL, a moving image or the like, the AP activation unit 110 according to the embodiment, in order to display data linked with it on another screen, automatically activates another application, and thereby can implement the coordination among multiple screens.

### 5. Another Embodiment

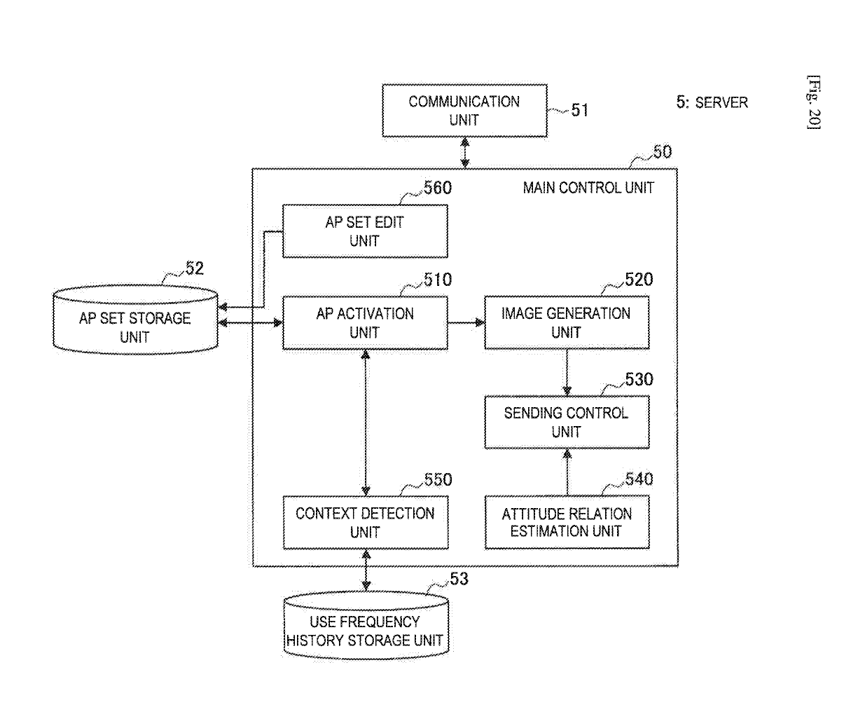

The display control process in the information processing apparatus 1 according to the embodiment described above is performed locally. However, the display control. process according to the embodiment is not limited to this, and can be also implemented in, for example, a display control system including a user terminal and a server 5 (an information processing apparatus according to an embodiment of the present disclosure). In the following, the concrete description will be made with reference to FIG. 20.

FIG. 20 is a block diagram showing a configuration of the server 5 included in a display control system according to another embodiment of the present disclosure. As shown in FIG. 20, the server 5 includes a main control unit 50, a communication unit 51, an AP set storage unit 52 and a use frequency history storage unit 53. The

AP set storage unit 52 and the use frequency history storage unit 53 are the same as the AP set storage unit 12 and the use frequency history storage unit 13 according to the first embodiment, and therefore the descriptions are omitted here.

### (Communication Unit)

The communication unit 51 has a function to connect with a user terminal possessed by a user and other external apparatuses such as various servers through a network, and to perform the sending and receiving of data. For example, the communication unit 51 receives, from the user terminal, the information about the operation input by a user, the information detected by the gyro sensor 15, pickup images acquired by the camera module 16, and the like. Further, in accordance with the control by a sending control unit 530, the communication unit 51 sends, to the user terminal, the display information about screens that are generated by an image generation unit 520 and that correspond to applications.

### (Main Control Unit)

The main control unit 50 is constituted by a microcomputer including a CPU, a ROM, a RAM, a nonvolatile memory and an interface unit, for example, and controls each constituent of the server 5. Further, as shown in FIG. 20, the main control unit 50 according to the embodiment functions as an AP activation unit 510, the image generation unit 520, the sending control unit 530, an attitude relation estimation unit 540, a context detection unit 550 and an AP set edit unit 560.

The AP activation unit 510, the image generation unit 520, the attitude relation estimation unit 540, the context detection unit 550 and the AP set edit unit 560 have the same functions as the AP activation unit 110, the image generation unit 120, the attitude relation estimation unit 140, the context detection unit 150 and the AP set edit unit 160 according to the first embodiment.

The sending control unit 530 sends multiple images generated by the image generation unit 520 from the communication unit 51 to the user terminal, and functions as a display control unit to perform such a control that they are arrayed in parallel and displayed on the display unit of the user terminal.

As described above, in the display control system according to the embodiment, the server 5 (the cloud side) shown in FIG. 20 performs the main process of the display control, and therefore, it is possible to reduce the processing burden of the user terminal.

### 6. Conclusion

As described above, the information processing apparatus 1 according to the embodiment of the present disclosure can switch multiple screens (a window group) corresponding to multiple applications, to multiple other screens, in response to a single external input (one action). The switching of multiple screens is performed on an application set basis.

Further, since the multiple screens are arrayed in parallel and displayed on the display unit 14, it is possible to use multiple applications seamlessly and simultaneously, without performing an explicit switching to individual applications.

Further, the information processing apparatus 1 according to the embodiment acquires current contexts, and can perform an instant switching to an appropriate application set in response to the current contexts.

Further, the information processing apparatus 1 according to the embodiment can implement the data coordination among multiple screens that are arrayed and displayed on the display unit 14, in response to an explicit instruction by a user operation, or an implicit link.

So far, the preferred embodiments of the present disclosure have been described in detail with reference to the accompanying drawings, but the present technology is not limited to the examples. It is apparent that a person ordinarily skilled in the art of the present disclosure can conceive various modifications and alternations within the scope of the technical idea described in the claims, and it should be understood that those naturally fall within the technical scope of the present disclosure.

For example, it is possible to create a computer program for exerting the functions of the information processing apparatus 1 and server 5 described with reference to FIG. 2 and FIG. 20, in hardware such as the CPU 10, the ROM 11 and the RAM 12, which are incorporated in the information processing apparatus 1 and the server 5. Also, a computer-readable storage medium in which the computer program is stored is provided.

Further, the steps in the process of the information processing apparatus 1 in the specification do not necessarily have to be processed in time series along the order disclosed in the accompanying flowcharts. For example, the steps in the process of the information processing apparatus 1 may be processed in a different order from the order described as the flowcharts, or may be processed in parallel.

The effects described in the specification are just explanatory or exemplary effects, and are not limiting. That is, the technology according to the present disclosure can exhibit other effects that are apparent to a person skilled in the art from the descriptions in the specification, along with the above effects or instead of the above effects.

Additionally, the present technology may also be configured as below.

(1)

An information processing apparatus including:

an activation unit to activate multiple applications in response to an external input;

an image generation unit to generate multiple screens corresponding to the multiple applications; and

a display control unit to perform such a control that the multiple screens generated by the image generation unit are displayed in parallel on a display screen,

wherein the display control unit performs such a control that a parallel display of first and second screens corresponding to first and second applications is switched to a parallel display of third and fourth screens corresponding to third and fourth applications, in response to a single external input.

(2)

The information processing apparatus according to (1),

wherein the display control unit performs the display switching, in response to a single external gesture action.

(3)

The information processing apparatus according to (1) or (2), further including:

an attitude relation estimation unit to estimate a relative attitude relation between the display screen and a viewing user,

wherein the display control unit rotates the multiple screens displayed in parallel on the display screen without changing screen sizes, in response to the attitude relation estimated by the attitude relation estimation unit.

(4)

The information processing apparatus according to any one of (1) to (3), further including:

a context detection unit to detect a context,

wherein the activation unit automatically activates an application in response to the context detected by the context detection unit.

(5)

The information processing apparatus according to (4),

wherein the context detection unit stores a use frequency history of an application for each context, and

wherein the activation unit automatically activates an appropriate application in response to a current context, based on the use frequency history.

(6)

The information processing apparatus according to any one of (1) to (5),

wherein the first and second applications and the third and fourth applications belong to different application sets from each other.

(7)

The information processing apparatus according to any one of (1) to (6),

wherein the display control unit performs a switching between the parallel display of the multiple screens and a full screen display of one screen, in response to a single external input, the one screen being contained in the multiple screens.

(8)

The information processing apparatus according to any one of (1) to (7),

wherein the display control unit sequentially switches the multiple screens displayed in parallel, to screens corresponding to other applications that belong to the identical application set, in response to a swipe operation input in a parallel direction in which the multiple screens are arrayed.

(9)

The information processing apparatus according to any one of (1) to (8),

wherein the display control unit expands/shrinks a display area of one screen in a parallel direction, in response to a drag operation input in the parallel direction in a vicinity of a border line of the one screen, the one screen being one of the multiple screens displayed in parallel.

(10)

The information processing apparatus according to any one of (1) to (9),

wherein the display control unit scrolls the multiple screens that belong to an application set, in response to a swipe operation input in a parallel direction, and

displays an addition screen for an application when the scrolling reaches an end of the application set, and

wherein the activation unit adds an application selected, to the application set, and activates the application, in response to an addition operation input on the addition screen.

(11)

The information processing apparatus according to any one of (1) to (10),

wherein the display control unit separates two adjacent screens in response to an operation input of pinching out the two screens, and newly displays an addition screen for an application between the two screens, and

wherein the activation unit adds an application selected, to the application set, and activates the application, in response to an addition operation input on the addition screen.

(12)

The information processing apparatus according to any one of (1) to (11),

wherein the display control unit performs such a control that one screen is hidden, in response to an operation input of pinching in two screens, the one screen being sandwiched between positions at which the two screens are displayed, and

wherein the activation unit terminates an application corresponding to the one screen hidden, and deletes the application from the application set.

(13)

The information processing apparatus according to any one of (1) to (12),

wherein the display control unit displays delete buttons on the multiple screens displayed in parallel respectively, in response to a long-press operation to a screen, and performs such a control that a screen corresponding to a delete button tapped is hidden, and

wherein the activation unit terminates an application corresponding to the screen hidden, and deletes the application from the application set.

(14)

The information processing apparatus according to any one of (1) to (13),

wherein, after a long-press operation to a screen, in response to a drag operation input in a parallel direction, the display control unit interchanges a display position of a screen displayed at a drag operation start position with a display position of a screen displayed at a drag operation end position,

(15)

The information processing apparatus according to any one of (1) to (14),

wherein the display control unit performs such a control that the parallel display of the first and second screens corresponding to the first and second applications is switched to the parallel display of the third and fourth screens corresponding to the third and fourth applications, in response to a swipe operation input in a direction perpendicular to a parallel direction in which the multiple screens are arrayed, the first and second applications belonging to a first application set, the third and fourth applications belonging to a second application set.

(16)

The information processing apparatus according to any one of (1) to (15),

wherein the display control unit scrolls the multiple screens that belong to an application set, in response to a scroll operation input in a parallel direction, and displays an edit screen for the application set when reaching a head of the application set, and

wherein the information processing apparatus further includes an application set edit unit to edit the application set in response to an edit operation input on the edit screen.

(17)

The information processing apparatus according to any one of (1) to (16),

wherein the image generation unit generates multiple screens corresponding to one application, and

wherein the display control unit performs such a control that the multiple screens corresponding to the one application are displayed in parallel on the display screen.

(18)

The information processing apparatus according to any one of (1) to (17),

wherein the activation unit coordinates data among the multiple screens displayed in parallel on the display screen.

(19)

A non-transitory computer-readable storage medium having a program stored therein,

the program making a computer function as:

an activation unit to activate multiple applications in response to an external input;

an image generation unit to generate multiple screens corresponding to the multiple applications; and

a display control unit to perform such a control that the multiple screens generated by the image generation unit are displayed in parallel on a display screen,

wherein the display control unit performs such a control that a parallel display of first and second screens corresponding to first and second applications is switched to a parallel display of third and fourth screens corresponding to third and fourth applications, in response to a single external input.

(20)

A control method including:

activating multiple applications in response to an external input;

generating multiple screens corresponding to the multiple applications;

performing such a control that the multiple screens generated are sent to a user terminal, and are displayed in parallel on a display screen of the user terminal; and

performing, with a processor, such a control that a parallel display of first and second screens displayed on the display screen and corresponding to first and second applications is switched to a parallel display of third and fourth screens corresponding to third and fourth applications, in response to a single external input.

(21)

An information processing system comprising: circuitry configured to

cause activation of multiple applications; cause generation of multiple windows corresponding to the multiple applications; and cause the multiple windows to be displayed in parallel on a display screen, wherein, in response to a single input, the circuitry causes a parallel display of first and second windows corresponding to first and second applications to switch to a parallel display of third and fourth windows corresponding to third and fourth applications,

(22)

The information processing system according (21), wherein the circuitry causes the display switching, in response to a single gesture action.

(23)

The information processing system according to any one of (21) to (22), wherein the circuitry is further configured to: control detection of an orientation, and control rotation of the multiple windows displayed in parallel on the display screen without changing screen sizes, based on the orientation.

(24)

The information processing system according to any one of (21) to (23), wherein the circuitry is further configured to: control detection of a context, and control activation of an application in response to the context detected.

(25)

The information processing system according to (24), wherein the circuitry controls storage of a use frequency history of an application for each context, and the circuitry causes automatic activation of an appropriate application in response to a current context, based on the use frequency history.

(26)

The information processing system according to any one of (21) to (25), wherein the first and second applications and the third and fourth applications belong to different application sets.

(27)

The information processing system according to any one of (21) to (26), wherein, in response to a single input, the circuitry causes a switching between the parallel display of the multiple windows and a full screen display of one window of the multiple windows.

(28)

The information processing system according to any one of (21) to (27), wherein, in response to a swipe operation in a direction parallel to a direction in which the multiple windows are arrayed, the circuitry causes sequential switching of the multiple windows displayed in parallel, to windows corresponding to other applications in a same application set.

(29)

The information processing system according to any one of (21) to (28), wherein the circuitry causes one of expanding or shrinking of a display area of one window in a parallel direction, in response to a drag operation input in the parallel direction near a border line of the one window, the one window being one of the multiple windows displayed in parallel.

(30)

The information processing system according to any one of (21) to (29), wherein the circuitry causes scrolling of the multiple windows that belong to an application set, in response to a swipe operation input in a parallel direction, and causes display of an addition window for an application upon reaching an end of the application set based on the scrolling, and the circuitry causes addition of an application selected, to the application set, and causes activation of the application, in response to an addition operation input on the addition window.

(31)

The information processing system according to any one of (21) to (30), wherein the circuitry causes separation of two adjacent windows in response to an operation input of pinching out the two windows, and causes display of an addition window for an application between the two windows, and the circuitry causes addition of an application selected, to the application set, and causes activation of the application, in response to an addition operation input on the addition window.

(32)

The information processing system according to any one of (21) to (31), wherein the circuitry causes a hiding of one window, in response to an operation input of pinching in two windows, the one window being sandwiched between positions at which the two windows are displayed, and the circuitry causes termination of an application corresponding to the one window hidden, and causes deletion of the application from the application set.

(33)

The information processing system according to any one of (21) to (32), wherein, in response to a long-press operation on a window, the circuitry causes display of delete buttons on the multiple windows displayed in parallel, and causes a window corresponding to a delete button tapped to be hidden, and the circuitry causes termination of an application corresponding to the window hidden, and deletes the application from the application set.

(34)

The information processing system according to any one of (21) to (33), wherein, after a long-press operation to a window and in response to a drag operation input in a parallel direction, the circuitry causes interchanging of a display position of a window displayed at a drag operation start position with a display position of a window displayed at a drag operation end position.

(35)

The information processing system according to any one of (21) to (34), wherein, in response to a swipe operation input in a direction perpendicular to a parallel direction in which the multiple windows are arrayed, the circuitry causes switching of the parallel display of the first and second windows corresponding to the first and second applications to the parallel display of the third and fourth windows corresponding to the third and fourth applications, the first and second applications belonging to a first application set, the third and fourth applications belonging to a second application set.

(36)

The information processing system according to any one of (21) to (35), wherein the circuitry causes scrolling of the multiple windows that belong to an application set, based on a scroll operation input in a parallel direction, and causes display of an edit screen for the application set when reaching a head of the application set, and the circuitry causes editing of the application set in response to an edit operation input on the edit screen.

(37)

The information processing system according to any one of (21) to (36), wherein the circuitry causes generation of multiple windows corresponding to one application, and that the circuitry causes display of the multiple windows corresponding to the one application in parallel on the display screen.

(38)

The information processing system according any one of (21) to (37), wherein the circuitry causes coordination of data among the multiple windows displayed in parallel on the display screen.

(39)

A non-transitory computer-readable storage medium encoded with computer-readable instructions thereon that, when executed by a computer, cause the computer to perform a method comprising: activating multiple applications; generating multiple windows corresponding to the multiple applications; displaying the multiple windows in parallel on a display screen; and in response to a single input, switching a parallel display of first and second windows corresponding to first and second applications to a parallel display of third and fourth windows corresponding to third and fourth applications.

(40)

A control method comprising: activating multiple applications; generating multiple windows corresponding to the multiple applications; sending the multiple windows generated to a user terminal, the multiple windows being displayed in parallel on a display screen of the user terminal; and switching, with circuitry and in response to a single input, a parallel display of first and second windows displayed on the display screen and corresponding to first and second applications to a parallel display of third and fourth windows corresponding to third and fourth applications.

### REFERENCE SIGNS LIST

1 information processing apparatus
10, 50 main control unit
110, 510 AP activation unit
120, 520 image generation unit
130 display control unit
530 sending control unit
140, 540 attitude relation estimation unit
150, 550 context detection unit
160, 560 AP set edit unit
5 server
21a to 21i, 26a to 26c, 27a to 27c, 28a screen
T1 to T11 operation

1. An information processing system comprising:
circuitry configured to
cause activation of multiple applications;
cause generation of multiple windows corresponding to the multiple applications; and
cause the multiple windows to be displayed in parallel on a display screen,
wherein, in response to a single input, the circuitry causes a parallel display of first and second windows corresponding to first and second applications to switch to a parallel display of third and fourth windows corresponding to third and fourth applications.

2. The information processing system according to claim 1,
wherein the circuitry causes the display switching, in response to a single gesture action.

3. The information processing system according to claim 1, wherein the circuitry is further configured to:
control detection of an orientation, and
control rotation of the multiple windows displayed in parallel on the display screen without changing screen sizes, based on the orientation.

4. The information processing system according to claim 1, wherein the circuitry is further configured to:
control detection of a context, and
control activation of an application in response to the context detected.

5. The information processing system according to claim 4,
wherein the circuitry controls storage of a use frequency history of an application for each context, and
the circuitry causes automatic activation of an appropriate application in response to a current context, based on the use frequency history.

6. The information processing system according to claim 1,
wherein the first and second applications and the third and fourth applications belong to different application sets.

7. The information processing system according to claim 1,
wherein, in response to a single input, the circuitry causes a switching between the parallel display of the multiple windows and a full screen display of one window of the multiple windows.

8. The information processing system according to claim 1,
wherein, in response to a swipe operation in a direction parallel to a direction in which the multiple windows are arrayed, the circuitry causes sequential switching of the multiple windows displayed in parallel, to windows corresponding to other applications in a same application set.

9. The information processing system according to claim 1,
wherein the circuitry causes one of expanding or shrinking of a display area of one window in a parallel direction, in response to a drag operation input in the parallel direction near a border line of the one window, the one window being one of the multiple windows displayed in parallel.

10. The information processing system according to claim 1,
wherein the circuitry causes scrolling of the multiple windows that belong to an application set, in response to a swipe operation input in a parallel direction, and causes display of an addition window for an application upon reaching an end of the application set based on the scrolling, and
the circuitry causes addition of an application selected, to the application set, and causes activation of the application, in response to an addition operation input on the addition window.

11. The information processing system according to claim 1,
wherein the circuitry causes separation of two adjacent windows in response to an operation input of pinching out the two windows, and causes display of an addition window for an application between the two windows, and
the circuitry causes addition of an application selected, to the application set, and causes activation of the application, in response to an addition operation input on the addition window.

12. The information processing system according to claim 1,
wherein the circuitry causes a hiding of one window, in response to an operation input of pinching in two windows, the one window being sandwiched between positions at which the two windows are displayed, and
the circuitry causes termination of an application corresponding to the one window hidden, and causes deletion of the application from the application set.

13. The information processing system according to claim 1,
wherein, in response to a long-press operation on a window, the circuitry causes display of delete buttons on the multiple windows displayed in parallel, and causes a window corresponding to a delete button tapped to he hidden, and
the circuitry causes termination of an application corresponding to the window hidden, and deletes the application from the application set.

14. The information processing system according to claim 1,
wherein, after a long-press operation to a window and in response to a drag operation input in a parallel direction, the circuitry causes interchanging of a display position of a window displayed at a drag operation start position with a display position of a window displayed at a drag operation end position.

15. The information processing system according to claim 1,
wherein, in response to a swipe operation input in a direction perpendicular to a parallel direction in which the multiple windows are arrayed, the circuitry causes switching of the parallel display of the first and second windows corresponding to the first and second applications to the parallel display of the third and fourth windows corresponding to the third and fourth applications, the first and second applications belonging to a first application set, the third and fourth applications belonging to a second application set.

16. The information processing system according to claim 1,
wherein the circuitry causes scrolling of the multiple windows that belong to an application set, based on a scroll operation input in a parallel direction, and causes display of an edit screen for the application set when reaching a head of the application set, and
the circuitry causes editing of the application set in response to an edit operation input on the edit screen.

17. The information processing system according to claim
wherein the circuitry causes generation of multiple windows corresponding to one application, and
that the circuitry causes display of the multiple windows corresponding to the one application in parallel on the display screen.

18. The information processing system according to claim 1,
wherein the circuitry causes coordination of data among the multiple windows displayed in parallel on the display screen.

19. A non-transitory computer-readable storage medium encoded with computer-readable instructions thereon that, when executed by a computer, cause the computer to perform a method comprising:
activating multiple applications;
generating multiple windows corresponding to the multiple applications;
displaying the multiple windows in parallel on a display screen; and
in response to a single input, switching a parallel display of first and second windows corresponding to first and second applications to a parallel display of third and fourth windows corresponding to third and fourth applications.

20. A control method comprising:
activating multiple applications;
generating multiple windows corresponding to the multiple applications;
sending the multiple windows generated to a user terminal, the multiple windows being displayed in parallel on a display screen of the user terminal; and
switching, with circuitry and in response to a single input, a parallel display of first and second windows displayed on the display screen and corresponding to first and second applications to a parallel display of third and fourth windows corresponding to third and fourth applications.
